(19) United States
(12) Patent Application Publication
(10) Pub. No.: US 2007/0165683 A1
(43) Pub. Date: Jul. 19, 2007

(54) Green laser optical module

(75) Inventor: Sung-Soo Park, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/641,206

(22) Filed: Dec. 19, 2006

(30) Foreign Application Priority Data
Jan. 16, 2006 (KR) 2006-4525

(51) Int. Cl. H01S 3/10; H01S 3/091; H01S 3/092

(52) U.S. Cl. 372/22; 372/70

(57) ABSTRACT

A green laser optical module includes a pumping laser, a solid-state laser, and a second harmonic generator. The pumping laser generates excitation light. The solid-state laser is excited by the excitation light and generates first light in an infrared wavelength band. The second harmonic generator converts the first light into second light in a green wavelength band and includes at least two polarization converting regions.

### CLAIM OF PRIORITY

This application claims priority under 35 U.S.C. § 119 to an application entitled “Green Laser Optical Module,” filed in the Korean Intellectual Property Office on Jan. 16, 2006 and assigned Serial No. 2006-4525, the contents of which are incorporated herein by reference.

### BACKGROUND OF THE INVENTION

1. Field of the Invention

The present invention generally relates to a laser optical module capable of generating a light in a green wavelength band, and in particular, to a green laser optical module for generating a green light through second modulation.

2. Description of the Related Art

Imaging devices of a scan type that forms an image by directly projecting laser oscillated lights in a visible wavelength band include light sources for generating the lights in the visible wavelength band. In general, the image devices of the scan type include lasers capable of generating lights in three color wavelength bands, e.g., blue, red, and green. Lights in the red and blue wavelength bands can be directly oscillated from a semiconductor laser.

Lights in the green wavelength band, on the other hand, are not easy to directly oscillate from a semiconductor or solid-state laser. To solve this problem, the light in the green wavelength band is oscillated using a second harmonic generator capable of generating second harmonics. This is used in conjunction with a solid-state laser capable of generating a light in an infrared wavelength band, and an optical module including a pumping laser for pumping the solid-state laser.

As the pumping laser, use may be made of a laser capable of generating an 808 nm pumping light, such as a Fabry Perot laser. A neodymium-doped yttrium aluminium garnet (Nd:Y₃Al₅O₁₂) laser, commonly known as an Nd:YAG laser, may serve as the solid-state laser. The solid-state laser oscillates the light in the infrared wavelength band after being pumped by the pumping light.

A bulk KTiOPO₄ (KTP) having a nonlinear optical characteristic may be used as the second harmonic generator. The second harmonic generator reduces by half the wavelength of a light input from the solid-state laser. Thus, the light in the infrared wavelength band generated by the solid-state laser is converted, by the second harmonic generator, into the light in the green wavelength band.

FIG. 1 is a graph for explaining a change in the output characteristic of the second harmonic generator with a change in the ambient temperature. It is seen from the graph that, as temperature increases, the output efficiency of the solid-state laser decreases. To adapt to a change in temperature, the magnitude of current applied to the solid-state laser is increased, thereby changing the wavelength of the light generated by the solid-state laser. This, in turn, changes the wavelength of the light generated by the second harmonic generator.

FIG. 5 is a graph for explaining the operation characteristic of the second harmonic generator according to temperature. The X axis represents temperature, and the Y axis indicates the wavelength conversion efficiency of the second harmonic generator. The broken line indicates the operation characteristic of the second harmonic generator in an ideal state, and the solid line shows the operation characteristic of the second harmonic generator in an actual state. It can be seen that the range within which is found a temperature usable by the actual second harmonic generator is relatively smaller than the corresponding range of the ideal second harmonic generator.

FIG. 6 is a view for explaining wavelength conversion of the second harmonic generator. A second harmonic generator 200 that is a bulk KTP passes some 201 of lights incident to a point A therethrough without performing wavelength conversion. The second harmonic generator 200 performs wavelength conversion on the remaining lights 202a, 202b in the infrared wavelength band, which are incident to points B and C. The wavelength converted lights output from a point C may undergo degradation in conversion efficiency due to destructive interference caused by a phase difference between conversion points.

In other words, when using a green laser optical module using a conventional second harmonic generator, wavelength conversion efficiency may be degraded and the converted wavelength of the light may be moved to an undesired wavelength band due to a change in the ambient temperature.

### SUMMARY OF THE INVENTION

To address the above-noted deficiencies in the prior art, the present invention provides a green laser optical module which minimizes wavelength conversion according to a change in temperature and can operate over a wide temperature range.

According to one aspect, there is provided a green laser optical module including a pumping laser, a solid-state laser, and a second harmonic generator. The pumping laser generates excitation light. The solid-state laser is excited by the excitation light and generates first light in an infrared wavelength band. The second harmonic generator converts the first light into second light in a green wavelength band and includes at least two polarization converting regions.

### BRIEF DESCRIPTION OF THE DRAWINGS

The above and other aspects, features and advantages of the present invention will become more apparent from the following detailed description when taken in conjunction with the accompanying drawings in which:

FIG. 1 is a graph for explaining a change in the output characteristic of a second harmonic generator with a change in the ambient temperature;

FIG. 2 is a block diagram of a green laser optical module according to the present invention;

FIG. 3 illustrates a second harmonic generator of FIG. 2;

FIG. 4 is a graph for comparing a conventional second harmonic generator and a second harmonic generator according to the present invention;

FIG. 5 is a graph for explaining the operation characteristic of a second harmonic generator according to temperature; and

FIG. 6 is a view for explaining wavelength conversion of a second harmonic generator.

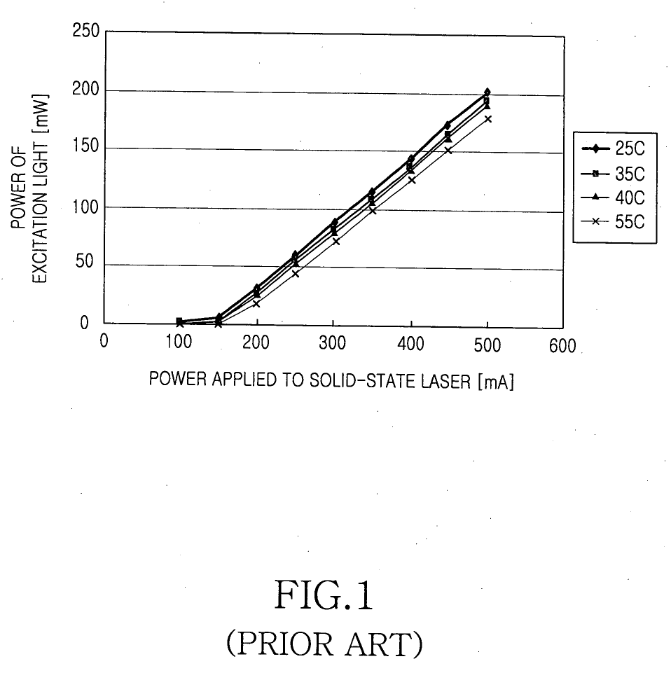

### DETAILED DESCRIPTION

In the discussion to following, detailed description of known functions and configurations incorporated herein is omitted for conciseness and clarity of presentation.

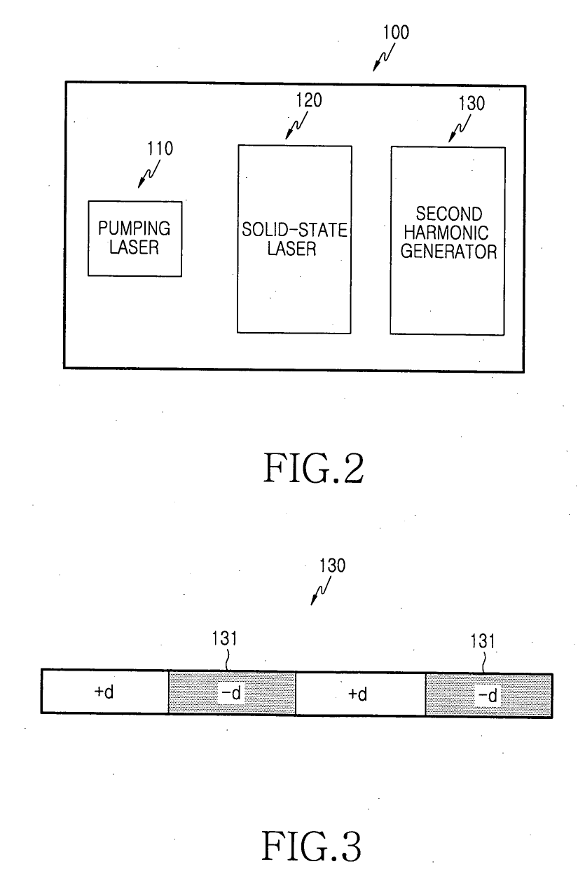

FIG. 2 depicts, by way of illustrative and non-limitative example, a green laser optical module 100 according to the present invention. The green laser optical module 100 includes a pumping laser 110 that generates excitation light, and a solid-state laser 120 that is excited by the excitation light and generates first light in an infrared wavelength band. The green laser optical module 100 further includes a second harmonic generator 130 that includes at least two polarization inverting regions and converts the first light into second light in a green wavelength band.

The pumping laser 110 may be a semiconductor laser such as a Fabry Perot laser capable of generating excitation light having a wavelength of 808 nm for exciting the solid-state laser 120. The solid-state laser 120, which may be an Nd:YAG laser, generates the first light in an infrared wavelength band after being excited by the excitation light.

FIG. 3 illustrates an exemplary realization of the second harmonic generator 130 of FIG. 2. Note that “d” in FIG. 3 represents the dipole, wherein “+d” and “−d” represent the dipole of opposite direction. The second harmonic generator 130 includes a plurality of polarization converting regions 131, indicated by (−d) in the drawing, that suppress the generation of destructive interference between second lights that are subject to wavelength conversion. Thus, the second harmonic generator 130 can improve wavelength conversion efficiency. As seen in FIG. 3, the polarization converting regions 131 are preferably spaced apart by intervening regions, so that the polarization converting regions are interleavingly arranged on the second harmonic generator 130. A path of light generated by the green laser optical module 100 passes, in series, through the two polarization converting regions 131.

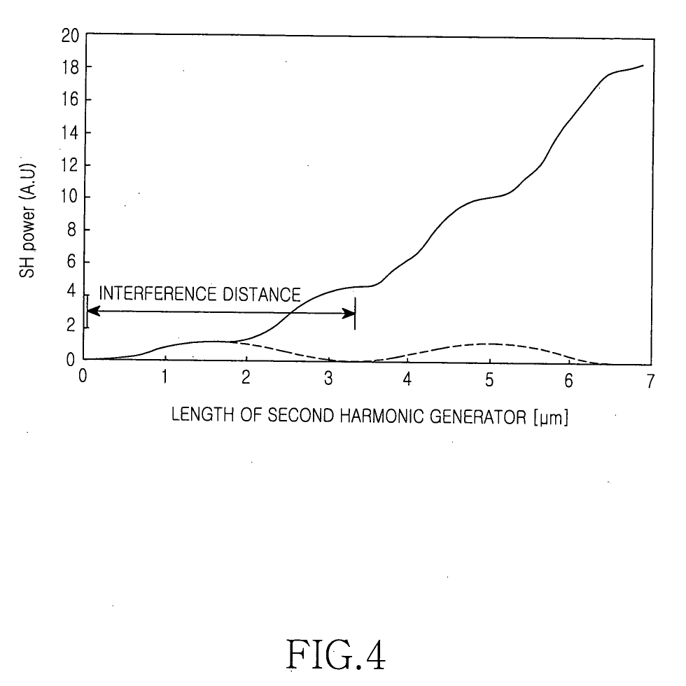

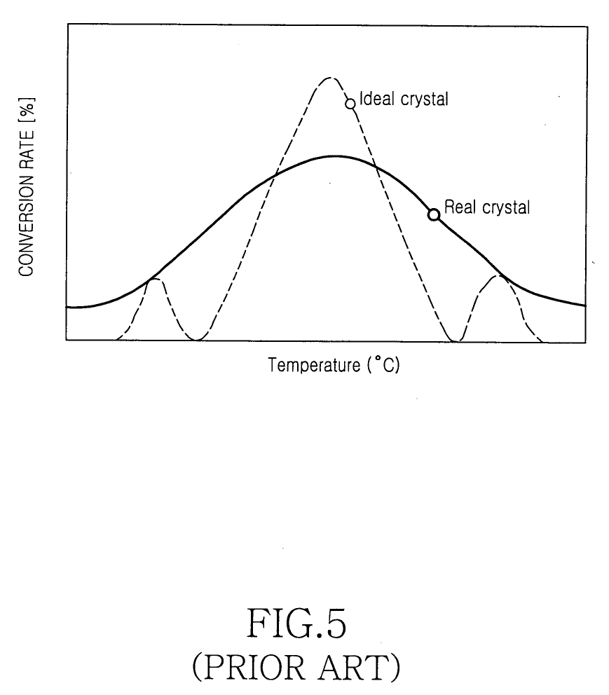

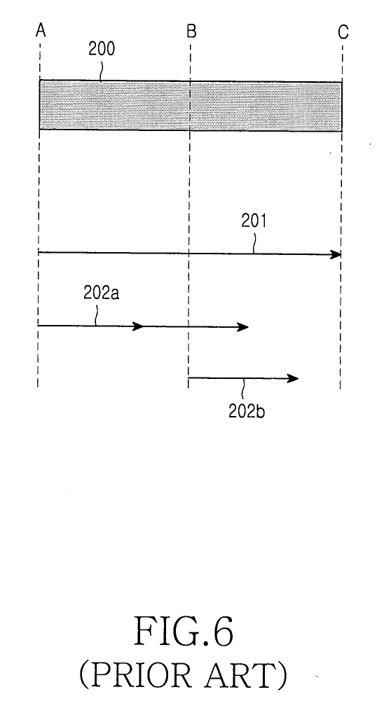

FIG. 4 is a graph comparing a conventional second harmonic generator with the second harmonic generator 130 according to the present invention. In FIG. 4, the broken line indicates the wavelength conversion efficiency of the second harmonic generator 130 according to the present invention and the solid line indicates the wavelength conversion efficiency of a conventional second harmonic generator applied in a conventional green laser optical module. The unit of Y-axis is <W> or <mV>, and in case of no polarization inversion, “interference distance” indicates the distance from the area occurring the phase matching to the area where the next phase matching occurs. It can be seen from FIG. 4 that the second harmonic generator 130 having the plurality of polarization converting regions 131 according to the present invention has nonlinear coefficient efficiency that is 3 times higher than that of the conventional second harmonic generator having no polarization converting regions.

The green laser optical module according to the present invention can therefore use a second harmonic generator having high-efficiency wavelength conversion and having small thickness. Moreover, by using a single-frequency laser for a pumping laser, the green laser optical module can operate over a wide temperature range without the need for separate cooling means.

As described above, the green laser optical module according to the present invention can minimize wavelength conversion according to a change in temperature and operate over a wide temperature range.

While the present invention has been shown and described with reference to a preferred embodiment thereof, it will be understood by those skilled in the art that various changes in form and details may be made therein without departing from the spirit and scope of the invention.

What is claimed is:

1. A green laser optical module comprising:
a pumping laser which generates excitation light;
a solid-state laser which is excited by the excitation light and generates first light in an infrared wavelength band; and
a second harmonic generator which converts the first light into second light in a green wavelength band and includes at least two polarization converting regions.

2. The green laser optical module of claim 1, wherein the pumping laser is a Fabry-Perot laser.

3. The green laser optical module of claim 1, wherein the excitation light uses a wavelength band of 808 nm.

4. The green laser optical module of claim 1, wherein the second harmonic generator comprises KTiOPO₄ (KTP) that includes the polarization converting regions.

5. The green laser optical module of claim 4, wherein two or more consecutive ones of said at least two polarization converting regions are respectively spaced apart by intervening one or more regions other than those comprising said at least two polarization converting regions.

6. The green laser optical module of claim 4, wherein said at least two polarization converting regions are interleavingly arranged on the second harmonic generator.

7. The green laser optical module of claim 4, configured such that a path of light generated by the green laser optical module passes, in series, through the at least two polarization converting regions.

8. The green laser optical module of claim 1, wherein the second harmonic generator comprises PPMgOLN that includes the polarization converting regions.

9. The green laser optical module of claim 8, wherein two or more consecutive ones of said at least two polarization converting regions are respectively spaced apart by intervening one or more regions other than those comprising said at least two polarization converting regions.

10. The green laser optical module of claim 8, wherein said at least two polarization converting regions are interleavingly arranged on the second harmonic generator.

11. The green laser optical module of claim 8, configured such that a path of light generated by the green laser optical module passes, in series, through the at least two polarization converting regions.

12. The green laser optical module of claim 1, wherein the pumping laser comprises a single-frequency laser.

13. The green laser optical module of claim 1, wherein two or more consecutive ones of said at least two polarization converting regions are respectively spaced apart by intervening one or more regions other than those comprising said at least two polarization converting regions.

14. The green laser optical module of claim 1, wherein said at least two polarization converting regions are interleavingly arranged on the second harmonic generator.

15. The green laser optical module of claim 1, configured such that a path of light generated by the green laser optical module passes, in series, through the at least two polarization converting regions.
